(19) United States
(12) Patent Application Publication
(10) Pub. No.: US 2007/0279599 A1
(43) Pub. Date: Dec. 6, 2007

(54) Projection apparatus

(75) Inventors: Atsushi Michimori, Tokyo (JP); Jyunichi Aizawa, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation, Tokyo (JP)

(21) Appl. No.: 11/802,708

(22) Filed: May 24, 2007

(30) Foreign Application Priority Data
May 29, 2006 (JP) 2006-148341

(51) Int. Cl. G03B 21/22

(52) U.S. Cl. 353/74

(57) ABSTRACT

In the case of a conventional screen holding structure, in the case where, due to external force, the case is deformed, the restoration of the case is insufficient due to the frictional force caused between each of the pressure members and the screen, even though the external force is removed. Accordingly, it has been a problem that relative positional misalignment between the optical engine and the screen is left, whereby image distortion is caused. A projection apparatus is configured in such a way that pressure members 201 and 203 that press in the direction which is perpendicular to the screen plane and hold the peripheral edges of a screen 20 are provided, and the pressing force that is applied by the pressure member 201 to the top edge of the screen 20 is smaller than the pressing force that is applied by the pressure member 203 to the bottom edge.

### BACKGROUND OF THE INVENTION

1. Field of the Invention

The present invention relates to a screen holding structure for a rear-projection-type television apparatus.

2. Description of the Related Art

The screen holding structure of a conventional projection apparatus is configured in such a way that the screen is fixed in an insertion manner, by means of pressure members and held by mounting members so as to be mounted in a case. All the four edges of the screen are configured in the same way (e.g., refer to Patent Document 1).

[Patent Document 1] Japanese Patent Application Laid-Open 2004-212953 (FIG. 7 in page 10)

For example, FIG. 12 is a structural analysis view for a case 3. It is assumed that, while the projection apparatus is installed or even after the projection apparatus has been installed, external force is applied to the top corners of the case 3 in the case where the projection apparatus is moved or the room is cleaned. For example, in some cases, force Pz(−) and force Pz(+) are applied to the top right and the top left, respectively, whereby the case 3 is deformed. It is known, from structural analysis as well as from actual measurement, that, in this case, a frame 10 that holds the periphery of a screen (unillustrated) is deformed, as a whole, to be a parallelogram, as if the top edge moved in the direction indicated by the arrow “D” in FIG. 13, when viewed in the direction “Z” in FIG. 12 (i.e., when the screen is viewed from front). The phenomenon will be explained with reference to FIG. 14 illustrating the deformation. FIG. 14(a) illustrates the state before the deformation; a screen 20 whose peripheral edges are pressed toward the plane (i.e., toward a viewer) by pressure members 201 (top edge), 202 (right edge), 203 (bottom edge), and 204 (left edge) is held by the frame 10 so that the positioning thereof is made. FIG. 14(b) illustrates the state after the deformation. Because its top edge moves in the direction “D”, the frame 10 is deformed to be a parallelogram; however, because being generally formed of a rectangular acrylate plate member, the screen 20 cannot be deformed to be a parallelogram on a plane, thereby maintaining the original rectangular shape. In other words, misalignment is caused between the screen 20 and each of the pressure members 201, 202, 203, and 204. Next, in the case where the external force is removed, because of the restoring force caused by its rigidity, the case 3 tries to restore itself to its original shape; however, in this situation, the frictional force caused between the screen 20 and each of the pressure members 201, 202, 203, and 204 prevents the case 3 from completely restoring itself. It has been a problem that, due to the residual deformation, the relative positional misalignment between an optical engine 6 and the screen 20 is left, whereby image distortion is caused.

### SUMMARY OF THE INVENTION

The present invention has been implemented in order to solve the foregoing problem; a projection apparatus according to the present invention is characterized by including a screen; an optical engine for projecting an image onto the rear side of the screen; a case for holding the screen and incorporating the optical engine; a frame, mounted on the case, for holding the peripheral sides of the screen; a top-edge pressure member for holding the top edge of the screen pressed in a screen-plane direction to the frame; a bottom-edge pressure member for holding the bottom edge of the screen pressed in the direction which is perpendicular to the screen plane to the frame; and pressing force by the top-edge pressure member being smaller than pressing force by the bottom-edge pressure member.

In a projection apparatus according to the present invention, the pressing force of a top-edge pressure member that holds the top edge of the screen pressed is made smaller than that of a bottom-edge pressure member that holds the bottom edge of the screen pressed so that the frictional force caused between the top edge of the screen and the top-edge pressure member is reduced; therefore, an effect is demonstrated in which, even when the case is deformed due to external force, the case readily restores itself to its original shape when the external force is removed, whereby a projection apparatus in which image misalignment and image distortion are reduced can be realized.

### BRIEF DESCRIPTION OF THE DRAWINGS

FIG. 1 is a configuration diagram illustrating a projection apparatus according to Embodiment 1 of the present invention;

FIG. 2 is a configuration diagram illustrating Embodiment 1 of the present invention;

FIG. 3 is an explanatory diagram for Embodiment 1 of the present invention;

FIG. 4 is a configuration diagram illustrating Embodiment 2 of the present invention;

FIG. 5 is a configuration diagram illustrating Embodiment 2 of the present invention;

FIG. 6 is a configuration diagram illustrating Embodiment 3 of the present invention;

FIG. 7 is a configuration diagram illustrating Embodiment 3 of the present invention;

FIG. 8 is a configuration diagram illustrating Embodiment 4 of the present invention;

FIG. 9 is a configuration diagram illustrating Embodiment 4 of the present invention;

FIG. 10 is a configuration diagram illustrating Embodiment 5 of the present invention;

FIG. 11 is a configuration diagram illustrating Embodiment 5 of the present invention;

FIG. 12 is an explanatory diagram illustrating deformation in a typical projection apparatus;

FIG. 13 is an explanatory diagram illustrating deformation in a typical projection apparatus; and

FIG. 14 is an explanatory diagram illustrating deformation in a typical projection apparatus.

### DETAILED DESCRIPTION OF THE PREFERRED EMBODIMENTS

### Embodiment 1

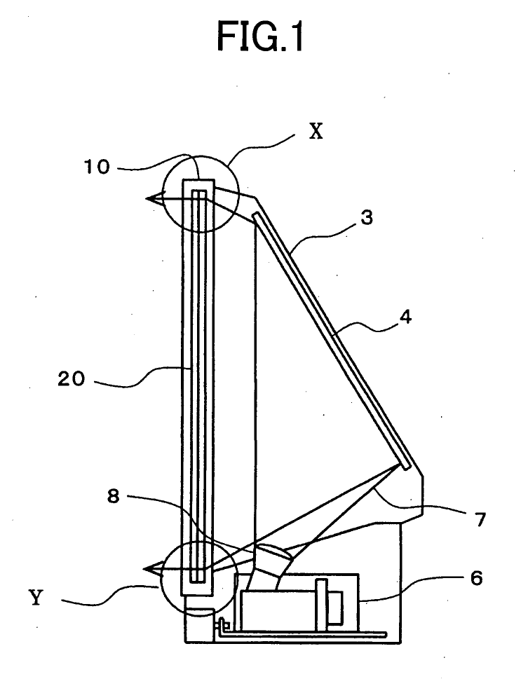

FIG. 1 is a configuration diagram illustrating a projection apparatus according to Embodiment 1 of the present invention; in FIG. 1, reference numeral 10 denotes a frame, mounted on a case 3, for holding a screen 20. Reference numeral 6 is an optical engine, mounted inside the case 3, for enlarging and projecting an image; an image 7 projected from a projection lens 8 is reflected by a mirror 4 mounted on the inner rear side of the case 3 and projected onto the rear side of the screen 20.

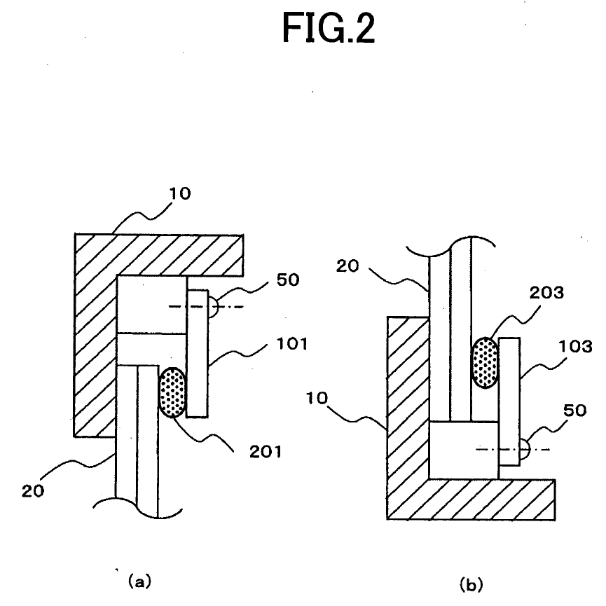

Next, the details of the fixing portion where the screen 20 is fixed in the frame 10 will be explained with reference to FIG. 2. FIGS. 2(a) and 2(b) are detailed cross-sectional views of the “X” portion (the top edge of the screen) in FIG. 1 and the ‘Y’ portion (the bottom edge of the screen) in FIG. 1, respectively. In FIG. 2(a), the screen 20 is mounted, behind the frame 10 (the right side, of the frame 10, in FIG. 2(a)), pressed and fixed by a pressure member 201 formed of an elastic material and a fixing member 101 that is fixed to the frame 10 by a screw 50. In FIG. 2(b), the screen 20 is mounted, behind the frame 10 (the right side, of the frame 10, in FIG. 2(b)), pressed and fixed by a pressure member 203 formed of an elastic material whose elastic modulus is different from that of the pressure member 201 and a fixing member 103 that is fixed to the frame 10 by the screw 50. In addition, FIG. 2(b) is different from FIG. 2(a) in that, due to its own weight, the screen 20 abuts on the frame 10 at its bottom end.

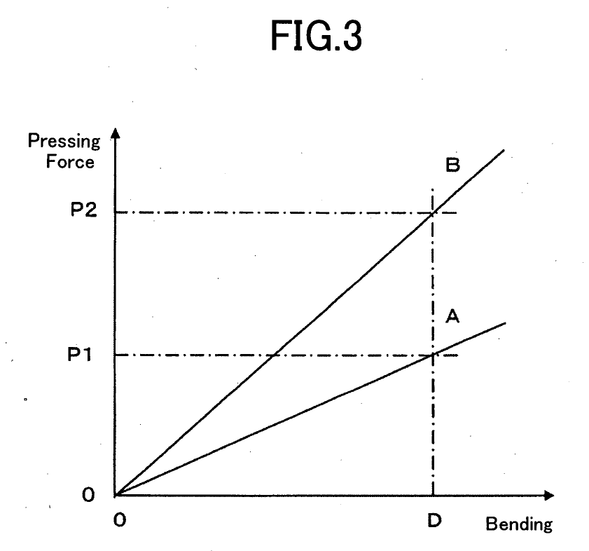

Next, the elastic moduli of the pressure members will be explained with reference to FIG. 3. In FIG. 3, the abscissa denotes the bending (in this case, the amount of contraction deformation) and the ordinate denotes the pressing force; the gradients of the lines “A” and “B” represent the elastic moduli of the pressure members 201 and 203, respectively. In FIG. 2, the pressure members 201 and 203 are mounted in such a way as to cause the same bending amount (“D” in this case), and on that occasion, the pressing forces to be generated for the pressure members 201 and 203 are P1 and P2, respectively, as represented in FIG. 3. P1 is smaller than P2; thus, the pressing force applied to the pressure member 201 is set to be smaller than that applied to the pressure member 203. It goes without saying that the pressing force applied to the pressure member 201 is set to be the same as or larger than the pressing force that is as large as can make the top edge of the screen 20 to be stably attached to the frame 10.

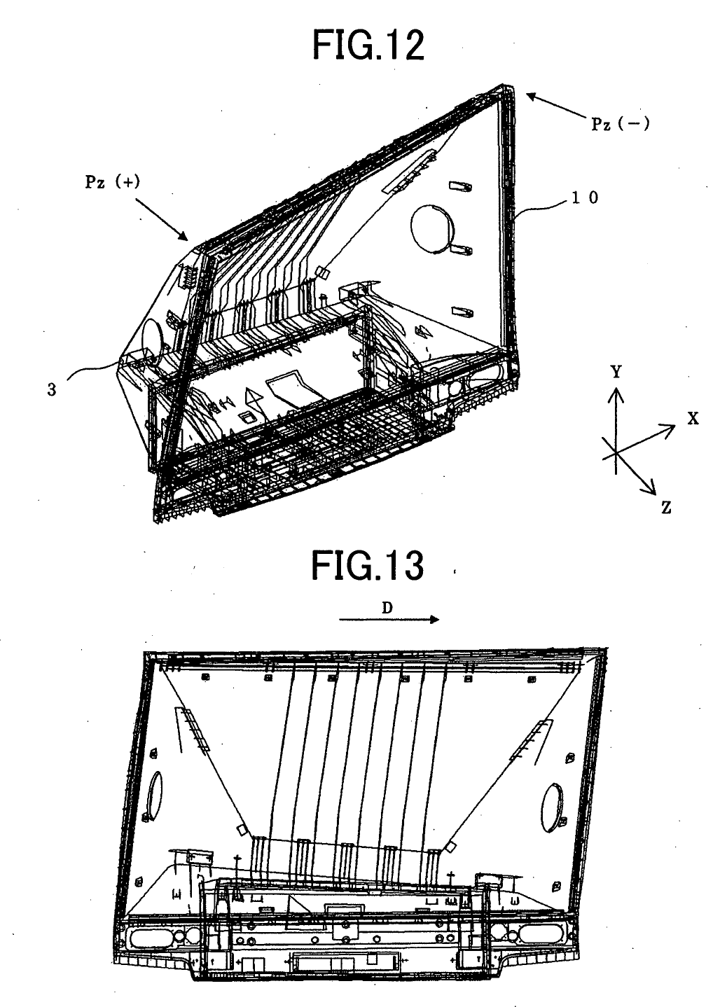

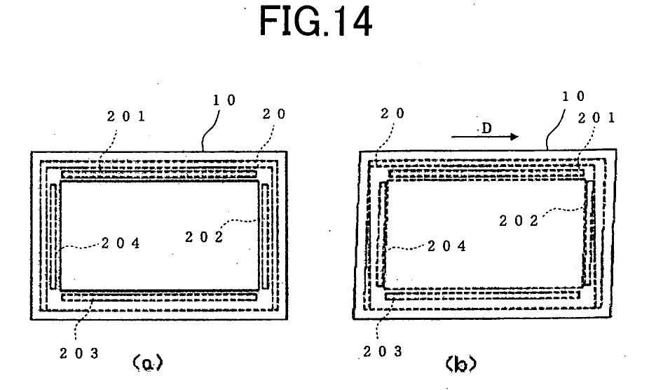

Next, the mechanism will be explained. As described above, in the case where a projection apparatus is installed, in the case where, after the installation, the projection apparatus is moved, or in the case where the room is cleaned, in some cases, external forces are applied to the top corners of the case 3, for example, as illustrated in FIG. 12, force Pz(−) and force Pz(+) are applied to the top right and to the top left, respectively, whereby the case 3 is twisted. In this case, the frame 10 that holds the periphery of the screen 10 is deformed, as a whole, to be a parallelogram, as if the top edge moved in the direction indicated by the arrow “D” in FIG. 13, when viewed in the direction “Z” in FIG. 12 (i.e., when the screen is viewed from front). Embodiment 1 will be explained with reference to FIG. 14 which is more simplified. FIG. 14(a) illustrates the state of the frame 10 before its deformation; the screen 20 is held by the frame 10 and the peripheral edges of the screen 20 are pressed toward the plane (i.e., toward a viewer) by the pressure members 201 (top edge), 202 (right edge), 203 (bottom edge), and 204 (left edge), so that the positioning of the screen 20 is made. FIG. 14(b) illustrates the state of the frame 10 after its deformation. Because its top edge moves in the direction “D”, the frame 10 is deformed to be a parallelogram; however, because being generally formed of an acrylate plate member, the screen 20 cannot be deformed to be a parallelogram on a plane, thereby maintaining the original rectangular shape. In other words, misalignment is caused between the screen 20 and each of the pressure members 201, 202, 203, and 204. In this situation, because, due to its own weight, the screen 20 abuts on the frame 10 at its bottom end, the frictional force in the abutting portion is applied to the screen 20, in addition to the pressing force by the pressure member 203 at the bottom end; as a result, the bottom edge of the screen 20 does not move with respect to the frame 10, whereby misalignment in the direction “D” is caused between the top edge of the screen 20 and the frame 10.

Next, the case where the external force is removed will be discussed. Because of the restoring force caused by the rigidity of the case 3, the case 3 and the frame 10 try to restore their original shapes. In this situation, because the pressing force of the top-edge pressure member 201 is set to be smaller than that of the bottom-edge pressure member 203, the frictional force applied to the top edge is small, whereby, even though misalignment at the top edge is large, that frictional force does not prevent the case 3 from restoring its original shape. Accordingly, the residual deformation in the case 3 can be reduced, whereby it is made possible to suppress the relative positional misalignment between the optical engine 6 and the screen 20; thus, Embodiment 1 has an effect of suppressing image distortion in a projection apparatus.

### Embodiment 2

In Embodiment 1, the projection apparatus is configured in such a way that, by making the elastic force of the top-edge pressure member 201 of the screen 20 smaller than that of the bottom-edge pressure member 203, the pressing force caused by the pressure member 201 is made smaller than that by the pressure member 203, for the same bending amount; however, the projection apparatus may be configured in such a way that, by making both the elastic forces of that pressure members the same and differentiating the initial thicknesses (the dimensions in the direction which is perpendicular to the screen plane in the case where no pressing force is applied) of that pressure members, thereby differentiating the bending amounts, the pressing forces are made different.

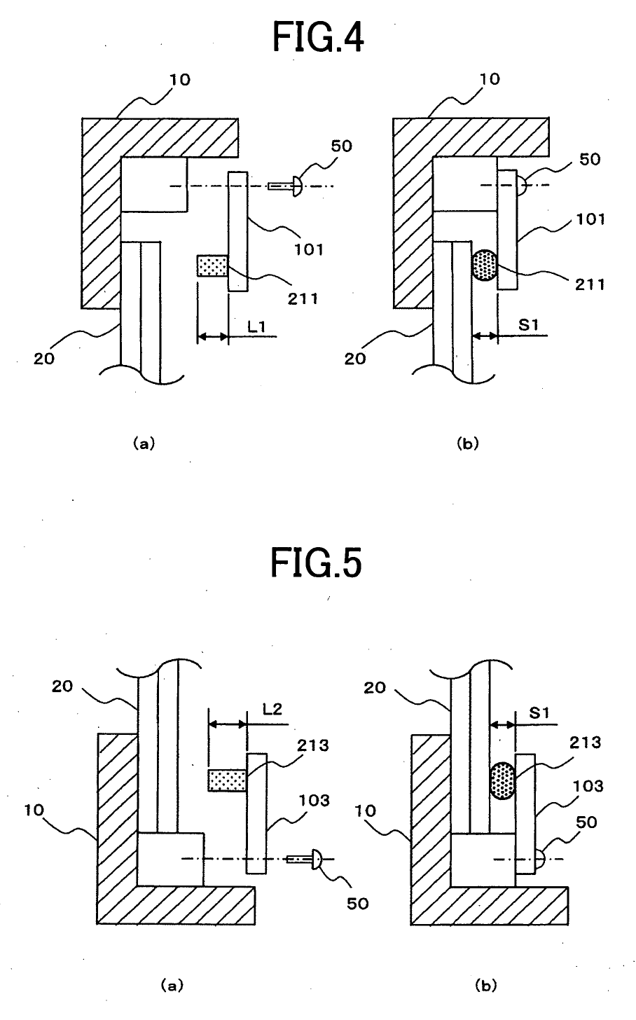

In FIG. 4, reference numeral 211 denotes a top-edge pressure member formed in such a way as to have a thickness of L1; after the fixing member 101 fixes the top-edge pressure member 211 to the screen 20, the top-edge pressure member 211 is held compressed to S1 in thickness. In FIG. 5, reference numeral 213 denotes a bottom-edge pressure member formed in such a way as to have a thickness of L2; after the fixing member 103 fixes the bottom-edge pressure member 213 to the screen 20, the bottom-edge pressure member 213 is held compressed to S1 in thickness. The initial thicknesses are formed in such a way that L1<L2; thus, after the fixation, the top-edge pressing force is smaller than that of the bottom-edge pressing force. The operation is the same as that in Embodiment 1; therefore, the detailed explanation therefor will be omitted.

### Embodiment 3

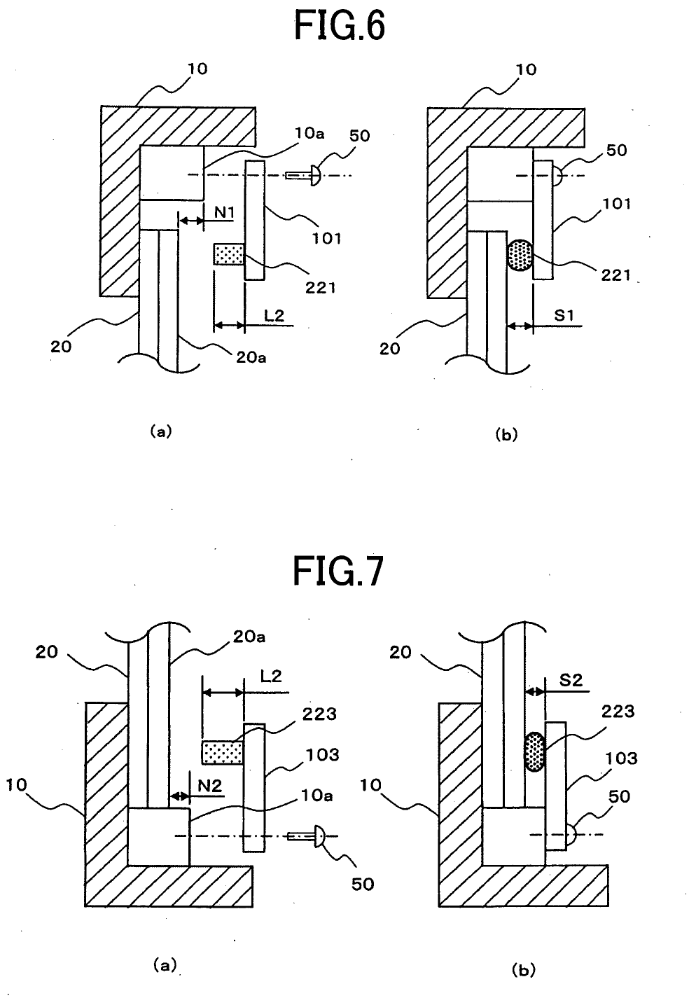

In Embodiment 2, the projection apparatus is configured in such a way that, by differentiating the initial thicknesses of the top-edge pressure member 211 and the bottom-edge pressure member 213, the pressing force caused by the pressure member 211 is made different from that caused by the pressure member 213; however, the projection apparatus may be configured in such a way that, by making the initial thicknesses the same and differentiating the thicknesses of the pressure members when being pressed so as to differentiate the contraction amounts, the pressing forces are made different from each other. In FIG. 6, a screen rear side 20a and a fixing member mounting surface 10a are formed in such a way as to have a dimensional difference N1. Reference numeral 221 denotes a top-edge pressure member formed in such a way as to have a thickness of L2; after the fixing member 101 fixes the top-edge pressure member 221 to the screen 20, the top-edge pressure member 221 is held compressed to S1 in thickness. In FIG. 7, the screen rear side 20a and the fixing member mounting surface 10a are formed in such a way as to have a dimensional difference N2. Reference numeral 223 denotes a bottom-edge pressure member formed in such a way as to have a thickness of L2; after the fixing member 103 fixes the bottom-edge pressure member 223 to the screen 20, the bottom-edge pressure member 223 is held compressed to S2 in thickness. The dimensional differences are formed in such a way that N1>N2; thus, after the fixation, the top-edge pressing force is smaller than that of the bottom-edge pressing force. The operation is the same as that in Embodiment 1; therefore, the detailed explanation therefor will be omitted.

### Embodiment 4

In Embodiment 3, the projection apparatus is configured in such a way that, by differentiating the contraction amounts of the top-edge pressure member 221 and the bottom-edge pressure member 223, the pressing force caused by the pressure member 221 is made different from that caused by the pressure member 223; however, the projection apparatus may be configured in such a way that, by making the contraction amounts the same and differentiating the initial cross-sectional areas (cross-sectional areas in the case where no pressing force is applied), the pressing forces are made different from each other.

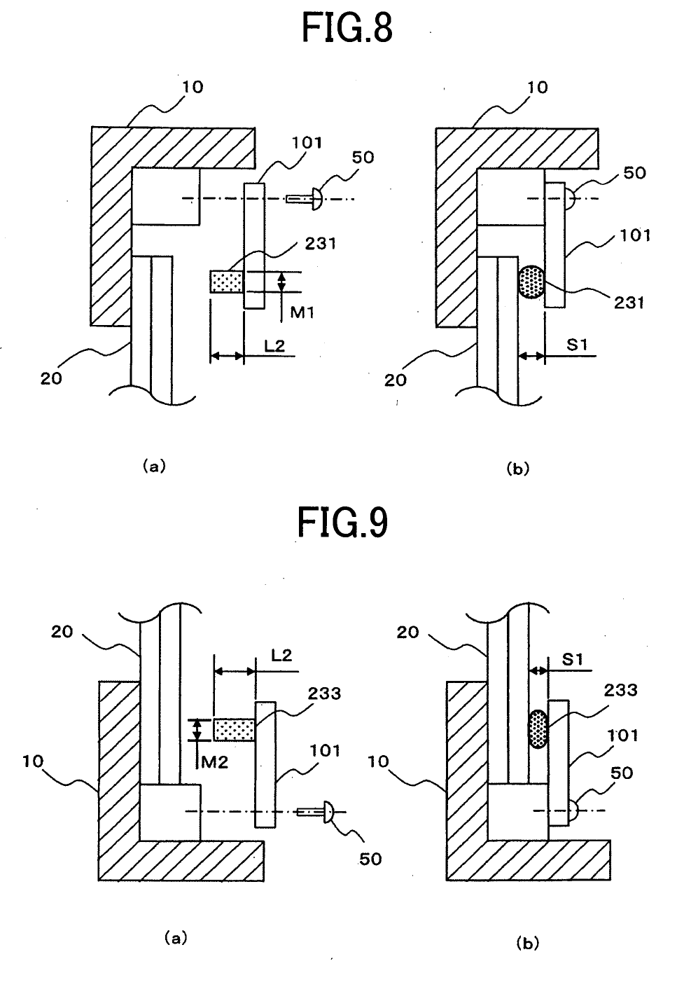

In FIG. 8, reference numeral 231 denotes a top-edge pressure member formed in such a way as to have an initial thickness of L2 and a width of M1, i.e., the initial cross-sectional area of L2×M1; after the fixing member 101 fixes the top-edge pressure member 231 to the screen 20, the top-edge pressure member 231 is held compressed to S1 in thickness. In FIG. 9, reference numeral 233 denotes a bottom-edge pressure member formed in such a way as to have an initial thickness of L2 and a width of M2, i.e., the initial cross-sectional area of L2×M2; after the fixing member 103 fixes the bottom-edge pressure member 233 to the screen 20, the bottom-edge pressure member 233 is held compressed to S1 in thickness. Because the widths are formed in such a way that M1<M2, the initial cross-sectional areas of the top-edge and bottom-edge pressure members are in such a way that (L2×M1)<(L2×M2); thus, after the fixation, the top-edge pressing force is smaller than that of the bottom-edge pressing force in the case where the contraction amounts are the same. The operation is the same as that in Embodiment 1; therefore, the detailed explanation therefor will be omitted.

### Embodiment 5

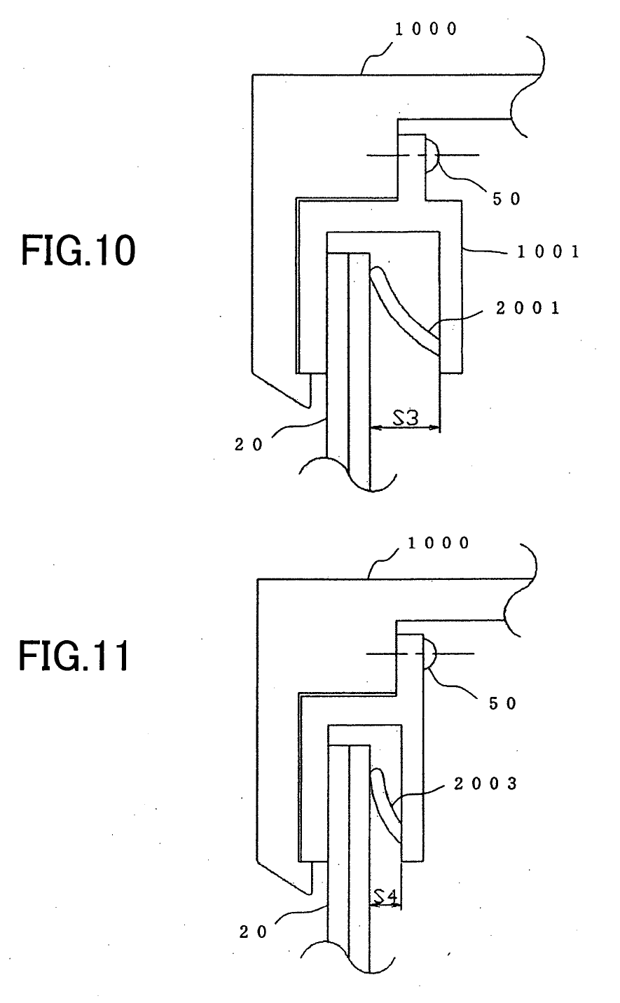

In Embodiments 1 to 4, the projection apparatus is configured in such a way that the screen 20 is mounted, behind the frame 10 (the right side, of the frame 10, in FIGS. 2, 4, 5 to 9), pressed and fixed by the pressure members 201 to 204, 211, 213, 221, 223, 231, and 233, which are sandwiched between the screen 20 and the fixing members 101 or 103 that is fixed to the frame 10 by the screw 50; however, as illustrated in FIG. 10, the projection apparatus may be configured in such a way that a frame 1001 is formed so as to have a U-shaped cross section and an elastic piece 2001 is disposed in a gap S3 inside the frame 1001 so that pressing force is applied to the screen 20. As illustrated in FIG. 11, for example, the width of the bottom-edge U-shaped cross section is set to be smaller than that of the top-edge U-shaped cross section and an elastic piece 2003 is disposed in a gap S4 so that pressing force is applied to the screen 20. In this situation, in the case where the elastic pieces 2001 and 2003 are each formed so as to have the same elastic modulus, the top-edge pressing force is made smaller than that of the bottom-edge pressing force, by making the gap width S3 larger than the gap width S4. The operation is the same as that in Embodiment 1; therefore, the detailed explanation therefor will be omitted.

### INDUSTRIAL APPLICABILITY

The present invention can be applied to a home-use or a professional-use projection-type television apparatus.

What is claimed is:

1. A projection apparatus comprising:
a screen;
an optical engine for projecting an image onto the rear side of the screen;
a case for holding the screen and incorporating the optical engine;
a frame, mounted on the case, for holding the peripheral edges of the screen;
a top-edge pressure member for holding the top edge of the screen pressed in a screen-plane direction to the frame;
a bottom-edge pressure member for holding the bottom edge of the screen pressed in the direction which is perpendicular to the screen plane to the frame; and
pressing force by the top-edge pressure member being smaller than pressing force by the bottom-edge pressure member.

2. The projection apparatus according to claim 1, wherein the elastic modulus of the top-edge pressure member is smaller than the elastic modulus of the bottom-edge pressure member.

3. The projection apparatus according to claim 1, wherein the initial thickness of the top-edge pressure member is smaller than the initial thickness of the bottom-edge pressure member.

4. The projection apparatus according to claim 1, wherein the contraction amount of the top-edge pressure member is smaller than the contraction amount of the bottom-edge pressure member.

5. The projection apparatus according to claim 1, wherein the initial cross-sectional area of the top-edge pressure member is smaller than the initial cross-sectional area of the bottom-edge pressure member.
